(19) United States
(12) Patent Application Publication
(10) Pub. No.: US 2025/0155557 A1
(43) Pub. Date: May 15, 2025

(54) MEASUREMENT SYSTEM

(71) Applicant: Red Sensors Limited, Leicester (GB)

(72) Inventors: David Mark Barnett, Leicester (GB); Ian Karl Buehring, Leicester (GB)

(21) Appl. No.: 18/832,206

(22) PCT Filed: Jan. 17, 2023
(86) PCT No.: PCT/GB2023/050081

§ 371 Date: Jul. 23, 2024

(30) Foreign Application Priority Data
Jan. 27, 2022 (GB) 2201073.0

(51) Int. Cl. G01S 7/4865; G01S 17/10

(52) U.S. Cl. CPC G01S 7/4865; G01S 17/10

(57) ABSTRACT

Disclosed is a measurement system comprising a first time determining device, a second time determining device and a clock signal system. The first time determining device is arranged to receive a first clock signal from the clock signal system and use it as a reference to determine a first time for an event signal that the first time determining device is arranged to receive. The second time determining device is arranged to receive a second clock signal from the clock signal system and use it as a reference to determine a second time for the event signal that the second time determining device is also arranged to receive. The first clock signal and the second clock signal are out of phase with each other.

### TECHNICAL FIELD

The present disclosure relates to measurement systems and particularly, but not exclusively, to measurement systems used to determine the times of event signals in light detection and ranging, LIDAR, systems. Aspects of the invention relate to a measurement system, a measurement method, a computer program, a non-transitory computer readable storage medium and a signal.

### BACKGROUND

Measurement systems are known which determine the time of an event signal. By way of example, LIDAR systems use a time determining device to determine the times at which a laser pulse leaves and returns to the (LIDAR) system having been backscattered from an object. The difference between these times can be used as a time of flight for the laser pulse, which can then be multiplied by the speed of light and divided by two to give the distance to the object.

To determine the time of the event signal, the time determining device uses a reference clock signal. The time determining device provides timing with a resolution and accuracy orders of magnitude above the frequency of the reference clock. Because the ultimate time determination is dependent on the reference clock signal, this means that there is inaccuracy in the determined time, the inaccuracy being dependent on the time of the event relative to the most recent reference clock pulse.

It is an object of embodiments of the invention to at least mitigate one or more of the problems of the prior art.

### SUMMARY OF THE INVENTION

According to a first aspect of the invention there is provided a measurement system comprising a first time determining device, a second time determining device and a clock signal system,
wherein the first time determining device is arranged to receive a first clock signal from the clock signal system and use it as a reference to determine a first time for an event signal that the first time determining device is arranged to receive,
and where further the second time determining device is arranged to receive a second clock signal from the clock signal system and use it as a reference to determine a second time for the event signal that the second time determining device is also arranged to receive,
wherein the first clock signal and the second clock signal are out of phase with each other.

The event signal may be generated in response to a single detection at a sensor (for instance a photodetector). Such a detection may give rise to a single detection signal in the form of the event signal.

Because the first and second clock signals are out of phase with each other (i.e. the timing pulses are out of phase) any offset error in the determination of the first time arising from the phasing of the actual time of the event signal with respect to the timing pulses of the first clock signal, will be different from any offset error in the determination of the second time arising from the phasing of the actual time of the event signal with respect to the timing pulses of the second clock signal. By averaging the first and second times, a more accurate determination of the actual time of the event signal is possible due to some degree of mutual cancellation of the offset errors in the first and second times in view of the difference in phase between the first and second clock signals. It is to be noted that this improvement in accuracy is distinct from any improvement that might occur as a result of averaging the times determined by a pair of time determining devices using in phase or independent clock signals for reference.

One or both of the time determining devices (first and second) may for instance be a time to digital converter (TDC) such as a tapped-delay line time to digital converter, a Vernier interpolator or a Ramp interpolator.

In some embodiments one or both of the time determining devices (first and second) may be a hybrid TDC. Alternately expressed, each time determining device (whether a hybrid TDC or otherwise) may utilise both a coarse measurement mechanism (e.g. a counter) and a fine measurement mechanism (e.g. comprising a tapped-delay line, a Vernier interpolator or a ramp interpolator) in determining its time, where the fine measurement mechanism measures fractions of a clock period. In such a time measurement device, the coarse measurement may provide for longer measurement periods (i.e. the continuous period over which time determinations may be made) than would be offered by the fine measurement alone, whilst the fine measurement may provide for greater resolution than would be offered by the coarse measurement alone. It may be that an error (e.g. a systematic error) occurring in terms of a determined time by one of the first and second TDCs is dependent on the delay between the relevant clock signal and the event signal. It is to be understood that such errors may not be the delay between the relevant clock signal and the event signal itself, or even caused by this delay, but may simply be dependent on the delay. Such errors have been shown empirically without their cause necessarily being known. In such cases, the technique recited herein to address such errors (whereby the first and second clock signals are out of phase and optionally in anti-phase with each other) may be applied. For instance, the technique may be applied with hybrid TDCs, which may exhibit such errors given for instance use of a counter and an interpolator for event signal time determination.

In some embodiments the first clock signal and the second clock signal are at least substantially in anti-phase with each other. This may allow for substantially complete cancellation of offset errors (arising in the manner discussed above) in the respective first and second time determining device times when an average is taken. Specifically, it may be that the respective offset errors would be substantially equal and opposite.

In some embodiments the clock signal system generates both the first and second clock signals from a single oscillator of the clock signal system by using the oscillator signal to derive the first clock signal and using an inverted form of the oscillator signal to derive the second clock signal. In this manner, greater accuracy may be achieved in creating and maintaining anti-phase between the first and second clock signals. It should be noted that in other embodiments the clock signal system may take an alternative form (e.g. phase matched crystals).

In some embodiments the measurement system comprises a processing system arranged to determine the time of the event signal as the average of the first and second times. The processing system may for instance comprise one or more processors and/or suitable electronics (digital or analogue).

In some embodiments the measurement system outputs the time of the event signal as determined by the processing system. This may be of assistance where the time of the event signal is desired/useful.

In some embodiments the first time determining device is arranged to receive a further event signal after receiving the event signal and to determine, using the first clock signal, a third time for the further event signal,
and the second time determining device is arranged to also receive the further event signal after receiving the event signal and to determine, using the second clock signal, a fourth time for the further event signal.

The further event signal may be generated in response to a single detection at a sensor (for instance a photodetector). Such a detection may give rise to a single detection signal in the form of the further event signal.

In some embodiments the measurement system is arranged to determine a difference in time between the event signal and the further event signal using averaging to account for the difference in the first and second times and the difference in the third and fourth times. The measurement system may for instance comprise a processor or suitable electronics to perform this function. The use of averaging to account for the difference may for instance be achieved by:
determining the time of the event signal as the average of the first and second times,
determining the time of the further event signal as the average of the third and fourth times,
and determining a difference in time between the event signal and further event signal as the difference between the average of the first and second times and the average of the third and fourth times.

Alternatively and similarly:
determining a difference in time between the event signal and the further event signal according to the first time determining device by determining the difference between the first time and the third time,
determining a difference in time between the event signal and the further event signal according to the second time determining device by determining the difference between the second time and the fourth time,
and determining that an average of these two differences is the difference in time between the event signal and further event signal.

The accuracy of the difference in time determination may be improved in a similar manner to a simple time determination. That is, a more accurate determination of the actual respective times of the event and further event signals is possible due to at least some degree of mutual cancellation of the offset errors in the first and second times and in the third and fourth times in view of the difference in phase between the first and second clock signals. As previously, it is to be noted that this improvement in accuracy is distinct from any improvement that might occur as a result of averaging the times determined by a pair of time determining devices using in phase or independent clock signals for reference.

In some embodiments the measurement system outputs the difference in time between the event signal and further event signal as determined by the processing system. This may be of assistance where the time between the event signal and the further event signal is desired/useful.

In some embodiments the measurement system is arranged for use with a light detection and ranging, LIDAR, system.

In some embodiments the event signal is indicative of the time that an incident laser pulse leaves the LIDAR system, the further event signal is indicative of the time that a corresponding backscattered laser pulse arrives at the LIDAR system and the difference in time between the event signal and further event signal as determined by the processing system is therefore a time of flight measurement. LIDAR systems may provide accuracy and resolution above a frequency of the reference clock. In this context, even slight offset errors in a determined event signal time resulting from an offset between the time of the event signal and the clock signal may be significant in terms of accuracy of the distance determined by the LIDAR system. Thus, the cancellation effect on such an offset as may be facilitated by the present invention may be significant in improving accuracy of the LIDAR system.

In some embodiments the processing system is arranged to multiply the time of flight measurement by the speed of light and divide the result by two to determine the distance to an object at which the incident laser pulse has been backscattered to produce the backscattered laser pulse.

In some embodiments the measurement system outputs the distance as determined by the processing system. This may be of assistance where the distance to the object is desired/useful.

According to a second aspect of the invention there is provided a measurement method comprising receiving a first clock signal, a second clock signal and an event signal and using the first clock signal as a reference to determine a first time for the event signal and using the second clock signal as a reference to determine a second time for the event signal, wherein the first clock signal and the second clock signal are out of phase with each other.

In some embodiments determining the first time for the event signal is performed using a first hybrid TDC and/or determining the second time for the event signal is determined using a second hybrid TDC. Alternately expressed, each time determination may utilise both a coarse measurement mechanism (e.g. a counter) and a fine measurement mechanism (e.g. comprising a tapped-delay line, a Vernier interpolator or a ramp interpolator) in determining its time, where the fine measurement mechanism measures a fraction of a clock period.

In some embodiments the first clock signal and the second clock signal are at least substantially in anti-phase with each other.

In some embodiments the measurement method comprises determining the time of the event signal as the average of the first and second times.

In some embodiments the measurement method comprises outputting the time of the event signal as determined.

In some embodiments the measurement method comprises receiving a further event signal after receiving the event signal and determining a third time for the further event signal using the first clock signal and determining a fourth time for the further event signal using the second clock signal.

In some embodiments the measurement method comprises determining a difference in time between the event signal and the further event signal using averaging to account for the difference in the first and second times and the difference in the third and fourth times.

In some embodiments the measurement method comprises outputting the difference in time between the event signal and further event signal as determined.

In some embodiments the measurement method is used as part of a light detection and ranging, LIDAR, system.

In some embodiments the event signal is indicative of the time that an incident laser pulse leaves the LIDAR system, the further event signal is indicative of the time that a corresponding backscattered laser pulse arrives at the LIDAR system and the difference in time between the event signal and further event signal as determined is therefore a time of flight measurement.

In some embodiments the measurement method comprises multiplying the time of flight measurement by the speed of light and dividing the result by two to determine the distance to an object at which the incident laser pulse has been backscattered to produce the backscattered laser pulse.

In some embodiments the measurement method comprises outputting the distance as determined.

According to a third aspect of the invention there is provided a computer program that, when read by a computer, causes performance of the method of the second aspect.

According to a fourth aspect of the invention there is provided a non-transitory computer readable storage medium comprising computer readable instructions that, when read by a computer, cause performance of the method according to the second aspect.

According to a fifth aspect of the invention there is provided a signal comprising computer readable instructions that, when read by a computer, cause performance of the method according to the second aspect.

Any controller or controllers described herein may suitably comprise a control unit or computational device having one or more electronic processors. Thus the system may comprise a single control unit or electronic controller or alternatively different functions of the controller may be embodied in, or hosted in, different control units or controllers. As used herein the term “controller” or “control unit” will be understood to include both a single control unit or controller and a plurality of control units or controllers collectively operating to provide any stated control functionality. To configure a controller, a suitable set of instructions may be provided which, when executed, cause said control unit or computational device to implement the control techniques specified herein. The set of instructions may suitably be embedded in said one or more electronic processors. Alternatively, the set of instructions may be provided as software saved on one or more memory associated with said controller to be executed on said computational device. A first controller may be implemented in software run on one or more processors. One or more other controllers may be implemented in software run on one or more processors, optionally the same one or more processors as the first controller. Other suitable arrangements may also be used.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described by way of example only, with reference to the accompanying drawings, in which:

FIG. 1 shows a schematic view of a measurement system for a LIDAR system;

FIG. 2 shows a schematic view of a measurement system for a LIDAR system according to an embodiment of the invention;

FIG. 3 shows a graph illustrating the effect of averaging measurements from two time to digital converters using anti-phase reference clock signals in accordance with an embodiment of the invention; and

FIG. 4 shows a timing diagram applicable to an embodiment of the invention.

### DETAILED DESCRIPTION

Referring first to FIG. 1, a measurement system (shown generally at 1) for a light detection and ranging, LIDAR, system is shown by way of illustration and introduction. The system 1 is arranged to determine the time between events (specifically in this case, the leaving of a laser pulse from the LIDAR system and the returning of the laser pulse once backscattered from an object). The time determined indicates a time of flight for the laser pulse, which can be multiplied by the speed of light and divided by two to give the distance from the LIDAR system to the object.

The system 1 has a time determining device, in this case a time to digital converter, TDC, 3 which has a leaving signal input 5 and a returning signal input 7 arranged to receive signals respectively indicating the timing of the leaving of a laser pulse and the return of the laser pulse. The TDC determines a time for the leaving of the laser pulse and a time for the return of the laser pulse by reference to a clock signal received via a clock signal input 9. The clock signal is supplied by an oscillator 11. The TDC outputs the determined time for the leaving signal via a leaving signal time output 13 and outputs the determined time for the return signal via a return signal time output 15. These outputs are sent to a difference calculator 17 which determines the difference in the times determined by the TDC and outputs this time difference for further use in determining the distance to the relevant object as discussed above.

The TDC may be arranged to provide greater resolution and superior accuracy by comparison with the reference clock. Consequently, there is a variable error component in any time determination made by such TDCs which is dependent on the relative phasing of the event time and the reference clock pulses.

In the case of a LIDAR detector, where the measurement of interest is the time between two events, it is possible, by chance (i.e. depending on when the events occur) that the respective phasing of the events with respect to the clock pulses is substantially the same, and that therefore the error described is substantially cancelled. The closer that the timing of the two events are to having the same phase with respect to the reference clock pulses, the greater the reduction in the effect of the offset error. This is because the nearer the offset is to being the same for both events, and so the nearer the two events are to having the same error in the same direction, the closer the respective errors are to being cancelled when considering a time interval between the events. However, for most measurements, this coincidence will not occur and so an inaccuracy of varying magnitude will be introduced to the distance calculated in accordance with the measured times. Further, in systems which do not determine a time between events, but simply determine and output the time of an event, a phase related inaccuracy in the measured time, of variable magnitude, will occur with no possibility of cancellation.

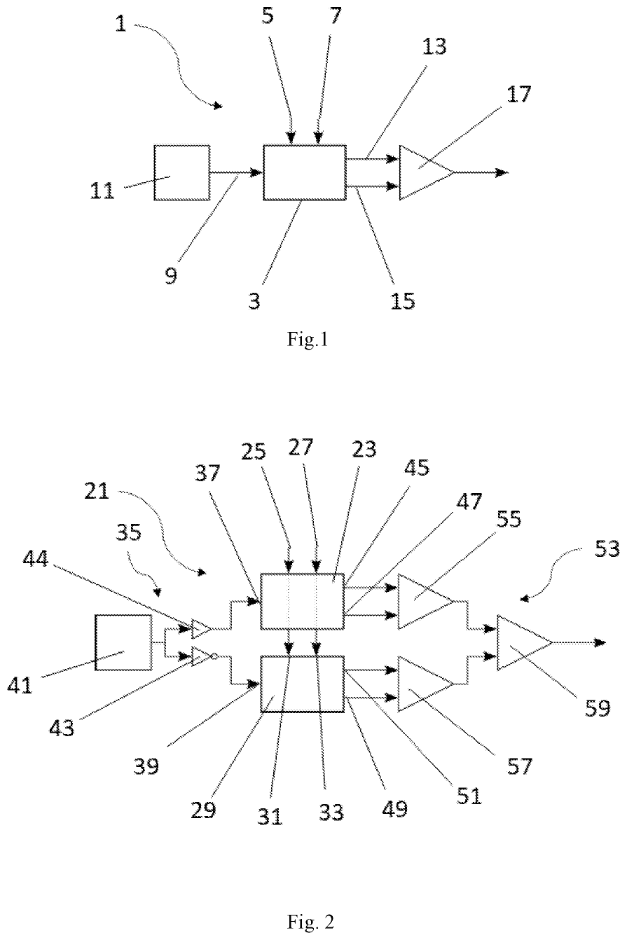

FIG. 2 shows a measurement system (shown generally at 21) for a light detection and ranging, LIDAR, system according to an embodiment of the invention. The LIDAR system is arranged to make a single distance determination for each laser pulse. The rate may be arbitrarily large, e.g. 100,000 per second or more. The system 21 is arranged to determine the time between events (specifically in this case, the time between an event signal indicative of the time of leaving of a laser pulse from the LIDAR system and a further event signal indicative of the time of returning of the laser pulse to the LIDAR system, it having been backscattered from an object). The time determined indicates a time of flight for the laser pulse, which can be multiplied by the speed of light and divided by two to give the distance from the LIDAR system to the object.

The system 21 has a first time to digital converter, TDC, 23 which has a leaving signal input 25 and a returning signal input 27 arranged to receive signals respectively indicating the timing of the leaving of a laser pulse and the return of the laser pulse.

The system 21 also has a second TDC 29 which has a leaving signal input 31 and a returning signal input 33 arranged to also receive the signals respectively indicating the timing of the leaving of the laser pulse and the return of the laser pulse.

Referring also to FIG. 4, each of the first 23 and second 29 TDCs independently determine a time for the leaving of the laser pulse. These times may be termed a first time (t₁) in the case the first TDC 23 and a second time (t₂) in the case of the second TDC 29. Each of the first 23 and second 29 TDCs also determine a time for the return of the laser pulse. These times may be termed a third time (t₃) in the case of the first TDC 23 and a fourth time (t₄) in the case of the second TDC 29. The first (t₁), second (t₂), third (t₃) and fourth (t₄) times are determined by the relevant TDC 23, 29 with reference to clock signals provided by a clock signal system generally shown at 35. A first clock signal, used by the first TDC 23 to determine the first (t₁) and third times (t₃), is received via a first TDC clock signal input 37. A second clock signal, used by the second TDC 29 to determine the second (t₂) and fourth (t₄) times, is received via a second TDC clock signal input 39. Both the first clock signal used by the first TDC 23 and the second clock signal used by the second TDC 29 are derived from a single (common) oscillator 41 of the clock signal system 35 (and indeed from common pulses outputted from the oscillator 41). However, the clock signal received by the second TDC 29 has passed through an inverter 43 of the clock signal system 31, provided in the signal path between the oscillator 41 and second TDC 29. No inversion has however been performed to the clock signal received by the first TDC 23 from the oscillator 41. In this embodiment, a buffer 44 is however used to provide a similar delay to the clock signal to be received by the first TDC 23 as is imparted by the inverter 43 to the clock signal to be received by the second TDC 29.

The action of the inverter 43 and buffer 44 means that the first clock signal and the second clock signal are out of phase with each other and indeed are substantially in anti-phase with each other as they are received by their respective TDCs 23, 29. Consequently, a phase difference Φ₁ between the first clock signal used by the first TDC 23 and the detection event for the leaving of the laser pulse, will be equal and opposite to a phase difference ¢2 between the second clock signal used by the second TDC 29 and the detection event for the leaving of the laser pulse. Consequently, any errors arising due to time offsets between the detection event for the leaving of the laser pulse and the respective first and second clock signals, will be equal and opposite. Similarly, a phase difference Φ₃ between the first clock signal used by the first TDC 23 and the detection event for the return of the laser pulse will be equal and opposite to a phase difference Φ₄ between the second clock signal used by the second TDC 29 and the detection event for the return of the laser pulse. Consequently, any errors arising due to time offsets between the detection event for the return of the laser pulse and the respective first and second clock signals, will be equal and opposite.

The first TDC 23 outputs the determined first time (t₁) via a leaving signal time output 45 and outputs the determined third time (t₃) via a return signal time output 47. The second TDC 29 outputs the determined second time (t₂) via a leaving signal time output 49 and outputs the determined fourth time (t₄) via a return signal time output 51.

The first (t₁), second (t₂), third (t₃) and fourth (t₄) times as determined are output from the respective TDC 23, 29 to a processing system generally shown at 53. More specifically, the first (t₁) and third (t₃) times are output by the first TDC 23 to a first difference calculator 55 of the processing system 53 and the second (t₂) and fourth (t₄) times are output by the second TDC 29 to a second difference calculator 57 of the processing system 53. The first difference calculator 55 determines the difference in the time for the leaving of the laser pulse and the time of the return of the laser pulse according to the first TDC 23. The first difference calculator 55 outputs this difference to an average calculator 59 of the processing system 53. The second difference calculator 57 determines the difference in the time for the leaving of the laser pulse and the time of the return of the laser pulse according to the second TDC 29. The second difference calculator 57 also outputs this difference to the average calculator 59 of the processing system 53. The average calculator 59 determines the average of the two time differences it receives from the first 55 and second 57 difference calculators, to give an average time of flight for the laser pulse according to the first 23 and second 29 TDCs. This time of flight is then used by the processing system 53 to determine the distance to the relevant object by multiplying it by the speed of light and dividing it by two.

Because the first and second clock signals are in anti-phase, (i.e. the timing pulses are in anti-phase) any offset error in the determination of the first time (t₁) arising from the phasing of the actual time of the corresponding event signal with respect to the timing pulses of the first clock signal, will be equal and opposite to any offset error in the determination of the second time (t₂) arising from the phasing of the actual time of the corresponding event signal with respect to the timing pulses of the second clock signal. Similarly, any offset error in the determination of the third time (t₃) arising from the phasing of the actual time of the corresponding event signal with respect to the timing pulses of the first clock signal, will be equal and opposite to any offset error in the determination of the fourth time (t₄) arising from the phasing of the actual time of the corresponding event signal with respect to the timing pulses of the second clock signal. Thus, when an average is taken of the time differential as determined based on the first (t₁) and third (t₃) time measurements of the first TDC 23 and the time differential as determined based on the second (t₂) and fourth (t₄) time measurements of the second TDC 29, the errors arising from the phasing of the actual time of the event signals with respect to the timing pulses of the respective clock signal are substantially cancelled. Thus, the average is a more accurate indication of the time between the leaving of the laser pulse and the return of the laser pulse, which in turn may lead to a more accurate distance to the object determination.

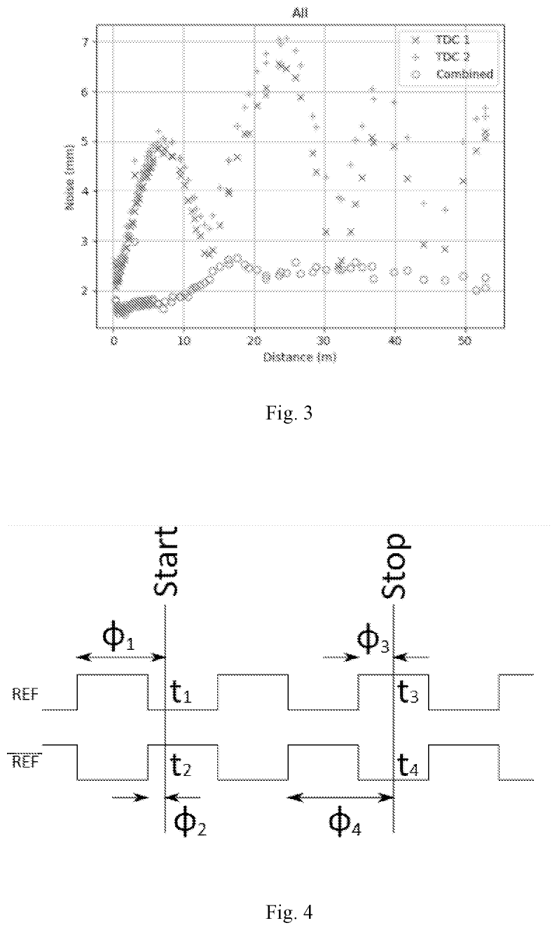

To illustrate, FIG. 3 shows the consequences of variations in the off-set between clock signal pulse and the relevant event (leaving or return of the laser pulse) which occur naturally with variation in distance to the scanned object. Clear and regular fluctuations in the noise levels (i.e. error) can be seen in the times recorded by each TDC as the distance to the scanned object varies (and so the offset between a clock signal pulse and the relevant event signal changes). The error is at a minimum where a clock signal pulse substantially coincides with the timing of the event signal. The error then increases to a maximum where the event signal occurs at a time spaced temporally equally between the clock signal pulse and the next such pulse. The error then decreases as the timing of the event signal approaches the next clock signal pulse. As can be seen however, the error is significantly reduced when averaging is used to combine the times as determined by the respective TDCs. This is because the TDCs use clock signals which are in anti-phase. It is to be noted that this improvement in accuracy is distinct from any improvement that might occur as a result of averaging the times determined by a pair of TDCs using in phase or independent clock signals for reference. Such an approach might reduce the effect of other errors, but would not address the phase error discussed above.

As will be appreciated, for convenience, the example above is provided in the context of a LIDAR detector. Nonetheless, the invention also has application in a detector simply arranged to determine the time of one or more events. That is, phase related error as discussed above can be mitigated by averaging times determined by two TDCs using reference clocks which produce pulses in anti-phase.

As will be further appreciated, the examples discussed above use reference clock pulses which are in anti-phase, but a more limited improvement (i.e. partial correction) in the phase related error can be achieved where the TDCs use reference clocks which produce out of phase pulses, without those pulses being in anti-phase.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine readable storage storing such a program. Still further, embodiments of the present invention may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. A measurement system, comprising:
a first time determining device;
a second time determining device; and
a clock signal system,
wherein the first time determining device is arranged to receive a first clock signal from the clock signal system and use it as a reference to determine a first time for an event signal that the first time determining device is arranged to receive,
and where further the second time determining device is arranged to receive a second clock signal from the clock signal system and use it as a reference to determine a second time for the event signal that the second time determining device is also arranged to receive,
wherein the first clock signal and the second clock signal are out of phase with each other.

2. The measurement system according to claim 1 where the first time determining device is a first hybrid TDC and/or the second time determining device is a second hybrid TDC.

3. The measurement system according to claim 1 where the first clock signal and the second clock signal are at least substantially in anti-phase with each other.

4. The measurement system according to claim 1 where the clock signal system generates both the first and second clock signals from a single oscillator of the clock signal system by using the oscillator signal to derive the first clock signal and using an inverted form of the oscillator signal to derive the second clock signal.

5. The measurement system according to claim 1 comprising a processing system arranged to determine a time of the event signal as an average of the first and second times.

6. The measurement system according to claim 5 which outputs the time of the event signal as determined by the processing system.

7. The measurement system according to claim 1,
where the first time determining device is arranged to receive a further event signal after receiving the event signal and to determine, using the first clock signal, a third time for the further event signal,
and the second time determining device is arranged to also receive the further event signal after receiving the event signal and to determine, using the second clock signal, a fourth time for the further event signal.

8. The measurement system according to claim 7, further comprising:
a processing system arranged to determine a difference in time between the event signal and the further event signal using averaging to account for the difference in the first and second times and the difference in the third and fourth times.

9. The measurement system according to claim 8 which outputs the difference in time between the event signal and further event signal as determined by the processing system.

10. The measurement system according to claim 9 arranged for use with a light detection and ranging, LIDAR, system.

11. The measurement system according to claim 10 where the event signal is indicative of the time that an incident laser pulse leaves the LIDAR system, the further event signal is indicative of the time that a corresponding backscattered laser pulse arrives at the LIDAR system and the difference in time between the event signal and further event signal as determined by the processing system is therefore a time of flight measurement.

12. The measurement system according to claim 11 where the processing system is arranged to multiply the time of flight measurement by the speed of light to determine a result and divide the result by two to determine a distance to an object at which the incident laser pulse has been backscattered to produce a backscattered laser pulse.

13. The measurement system according to claim 12 which outputs the distance as determined by the processing system.

14. A measurement method, comprising:
receiving a first clock signal, a second clock signal and an event signal and using the first clock signal as a reference to determine a first time for the event signal and using the second clock signal as a reference to determine a second time for the event signal, wherein the first clock signal and the second clock signal are out of phase with each other.

15. The measurement method according to claim 14 where determining the first time for the event signal is performed using a first hybrid TDC and/or determining the second time for the event signal is determined using a second hybrid TDC.

16. The measurement method according to claim 15 where the first clock signal and the second clock signal are at least substantially in anti-phase with each other.

17. A computer program that, when read by a computer, causes performance of the method of claim 15.

18. A non-transitory computer readable storage medium comprising computer readable instructions that, when read by a computer, cause performance of the method according to claim 15.

19. (canceled)
